(19) United States
(12) Patent Application Publication
(10) Pub. No.: US 2004/0097319 A1
(43) Pub. Date: May 20, 2004

(54) Method of manufacturing wobbling inner gearing planetary gear system and gear system

(76) Inventor: Yo Tsurumi, Chiryu-shi (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/383,226

(22) Filed: Mar. 7, 2003

(30) Foreign Application Priority Data
Mar. 8, 2002 (JP) 2002-64353

(51) Int. Cl. F16H 1/32

(52) U.S. Cl. 475/165

(57) ABSTRACT

The wobbling inner gearing planetary gear system has planetary external gears and an internal gear with which the external gears internally mesh, a center axis of the system being located inside periphery of the external gears The method is a method of reducing angle transmission errors in the system, in which the number of teeth of the internal gear is X·n (X: even number of 4 or more; n: integer), and the difference in the number of teeth between the internal gear and external gears is 2. The external gears are superposed and machined to collectively form respective external gear teeth and through holes. The external gears are grouped into pairs and these pairs are circumferentially offset from each other by 360°/X around the center axis. One of each pair of the external gears is shifted parallel in 180° opposite direction away from the other one of each pair of the external gears.

### BACKGROUND OF THE INVENTION

1. Field of the Invention

The present invention relates to a method of a wobbling inner gearing planetary gear system and a system assembled according to this method.

2. Description of the Related Art

FIG. 6 and FIG. 7 illustrate one prior art example of a wobbling inner gearing planetary gear system. The illustrated example is a wobbling inner gearing planetary gear system applied to a reducer, and includes a plurality of (three in this example) planetary external gears. Here, the center axis of the system is located inside the periphery of these external gears.

In a central portion of a casing 101 is disposed an input shaft 103 driven by a motor (not shown) to rotate. The input shaft 103 is coaxial with the center axis 01 of the system itself.

Inside the casing 101 is arranged a thick, disk-like first support block 104 (on the left side in FIG. 6) and a second support block 105 (on the right side) facing each other in axial direction. If the casing 101 is stationary, these first and second support blocks 104 and 105 function as an output shaft.

Both the support blocks 104 and 105 are integrally coupled and fixed by three carrier bolts 150 extending parallel to the input shaft 103, with a certain distance provided therebetween by a carrier spacer 154. These elements together form a carrier.

The first support block 104 and the second support block 105 have respective center holes 114 and 115, in which the input shaft 103 is supported by means of bearings 109a and 109b such as to be rotatable along the inner peripheries of the holes 114 and 115. The input shaft 103 is a hollow member having a through hole 103a. On the outer periphery of the input shaft 103 between the bearings 109a and 109b are integrally formed eccentric elements 117a, 117b, and 117c, which are offset from each other by a certain phase difference (120° in this example). Three external gears 118a, 118b, and 118c are attached to the eccentric elements 117a, 117b, and 117c by means of bearings 120a, 120b, and 120c, respectively.

Each of the external gears 118a, 118b, and 118c is provided with a plurality of inner roller holes 128a, 128b, and 128c, through which inner pins 107 and inner rollers 108 pass. These inner pins 107 passing through the external gears 118a, 118b, and 118c are arranged on the same pitch circle of the carrier bolts 150, and both axial ends of each inner pin 107 are fixedly fitted in respective inner pin retaining holes 110 formed in the first and second support blocks 104 and 105.

The external gears 118a, 118b, and 118c include external gear teeth 124 in a trochoidal profile or arc profile on their outer peripheries. On the outer peripheral side of the external gears 118a, 118b, and 118c is arranged an internal gear 125 that meshes with the external gears. The internal gear 125 is integrally formed on the inner periphery of the casing 101, and provided with internal gear teeth consisting of outer pins 126.

One turn of the input shaft 103 causes one turn of the eccentric elements 117a, 117b, and 117c, which in turn causes the external gears 118a, 118b, and 118c to wobbly rotate around the input shaft 103. At this time, because of the internal gear 125 restricting the rotation of the external gears 118a, 118b, and 118c around their own axes, they merely move along the wobbling path while inscribing with the internal gear 125.

If the number of teeth of the external gears 118a, 118b, and 118c is N, and the number of teeth of the internal gear 125 is N+1, the difference in the number of teeth between the inner and external gears is one. Because of this, every turn of the input shaft 103 causes the external gears 118a, 118b, and 118c to be shifted (rotated) by one tooth relative to the internal gear 125 fixed to the casing 101. This means that one turn of the input shaft 103 is reduced to 1/N turn of the external gears.

When this rotation of the external gears 118a, 118b, and 118c is transmitted to the output shaft via the inner pins 107, their wobbling component is absorbed by the gap between the inner roller holes 128a, 128b, and 128c and the inner pins 107, so that only their rotating component is transmitted.

As a result, a reduction rate of 1:1/N is achieved.

The provision of three external gears as with this prior art example increases power transmission capacity by three times as compared to a system with only one external gear.

The illustrated wobbling inner gearing planetary gear system is classified under a subgroup F16H1/32 of the International Patent Classification, because it includes planetary external gears 118a, 118b, and 118c and the system's center axis 01 is located inside the periphery of the external gears 118a, 118b, and 118c. This type of system generally has a problem of inevitable eccentric load (radial load) resulting from the wobbling motion of the external gears 118a, 118b, and 118c for every turn of the input shaft 103.

The reason why the three external gears 118a, 118b, and 118c are circumferentially arranged with a phase difference of 120° is to counterbalance the effects of eccentric loads of the respective external gears 118a, 118b, and 118c as much as possible so as to enable smooth power transmission with less vibration.

In response to the recent demands for reducers to be smaller and more powerful, it has been suggested that four or more external gears be assembled in a wobbling inner gearing planetary gear system for reducers. Such gear system with four or more external gears has not yet been manufactured for the following reasons.

Because of the structural characteristics of the gear system with four or more external gears, it could not impart smooth rotation if there were large manufacturing errors and assembling errors of the respective gears. On the other hand, an attempt to reduce the errors by increasing machining precision would result in extremely high costs.

Another problem in the system with four or more external gears is that because of the large axial span length of each external gear, the effects of eccentric load (as mentioned above) caused by the eccentric motion of each external gear are accordingly large; in particular, the effects of moment determined by the distance from the bearings are significant.

### SUMMARY OF THE INVENTION

The present invention has been devised under these circumstances, and an object thereof is to provide a method whereby the system is made compact and its transmission capacity increased, and whereby a high reduction/increase rate can be achieved while angle transmission errors are reduced, and a wobbling inner gearing planetary gear system assembled according to this method.

To solve the above problems, the present invention provides a method of manufacturing a wobbling inner gearing planetary gear system having planetary external gears and an internal gear with which the external gears internally mesh, wherein a center axis of the system is located inside periphery of the external gears, the method comprising the steps of: setting a number of teeth for the internal gear as X·n, where X is an even number of 4 or more and n is an integer, the internal gear and external gears having a difference of 2 in their number of teeth; machining the external gears in a number of X in a state wherein they are superposed upon one another to collectively form their respective external gear teeth and through holes; and assembling the external gears in the system in such an arrangement that the external gears are grouped into pairs and the pairs of the external gears are circumferentially offset relative to each other by 360°/X around the center axis, and that one of each pair of external gears is shifted parallel in 180° opposite direction away from the other one of each pair of external gears.

According to the present invention, the simultaneously machined X external gears are grouped into pairs and these pairs are circumferentially rotated by 360°/X relative to each other, and one of each pair of external gears is shifted parallel in 180° opposite direction away from the other one of each pair of external gears. Accordingly, the simultaneously machined external gear teeth of each pair of external gears mesh with the internal gear always at different timings by the offset of 180°.

Therefore, the angle transmission errors caused by machining errors of each external gear are well counterbalanced between each pair of external gears respectively offset in 180° opposite directions, whereby the angle transmission errors in the system as a whole are reduced.

Also, because the X external gears are equally spaced in the circumferential direction of the center axis, the loads created around the center axis are well counterbalanced within the system.

Because the difference in the number of teeth between the internal gear and the external gears is 2, a higher reduction rate is achieved as compared to the prior art method of simultaneously machining several external gears in which the difference in the number of teeth is a multiple of an integer of the number of external gears.

Because of the above construction, the number of external gears is an even number, and the number of teeth of the internal gear need to be X·n (n: integer), a multiple of an integer of X.

Incidentally, as for the moments created at axially different points of eccentric loads of each external gear, two of the X external gears forming the pairs may be respectively arranged adjacent to each other in the axial direction of the center axis, so that these moments caused by the eccentric motion of the external gears are well counterbalanced.

Further, the moments may be also well counterbalanced by arranging the X external gears successively along the axial direction of the center axis at a successively determined eccentric position where axially adjacent external gears are offset from each other by a maximum phase difference with reference to an eccentric position of an immediately previously mounted external gear.

### DESCRIPTION OF THE DRAWINGS

FIG. 1 is a sectional side view of a reducer adopting a wobbling inner gearing planetary gear system according to one embodiment of the present invention;

FIG. 2 is a model view of an input shaft and external gears of this gear system;

FIG. 3 is a model view illustrating a modification of the arrangement of FIG. 2, in which the layout of external gears in the axial direction is changed;

FIG. 4 is a model view of an input shaft and external gears of a six-gear system;

FIG. 5 is a diagram showing angle transmission errors in the wobbling inner gearing planetary gear system of FIG. 1;

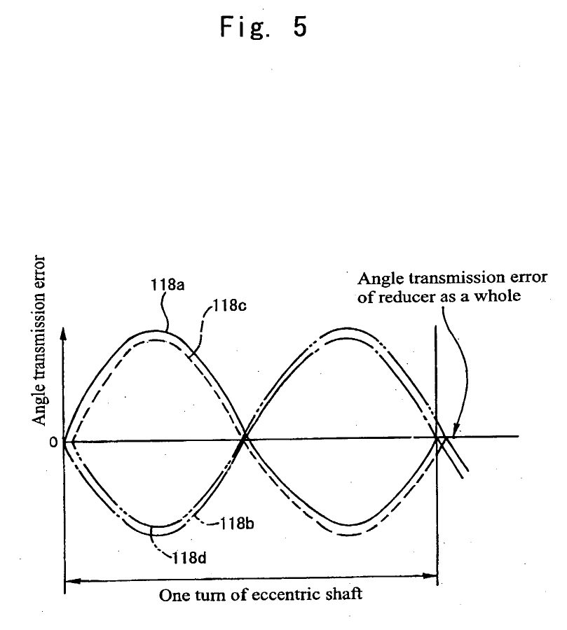

FIG. 6 is a sectional side view of a reducer adopting a conventional wobbling inner gearing planetary gear system;

FIG. 7 is a cross section taken along the line V-V of FIG. 6;

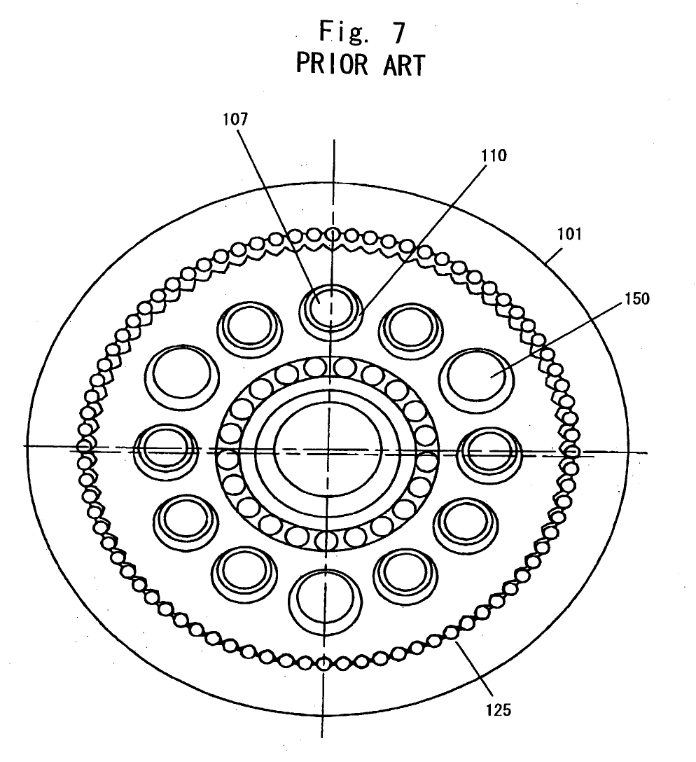

FIG. 8 is a diagram illustrating external gears and internal gear engaging each other of a conventional wobbling inner gearing planetary gear system; and

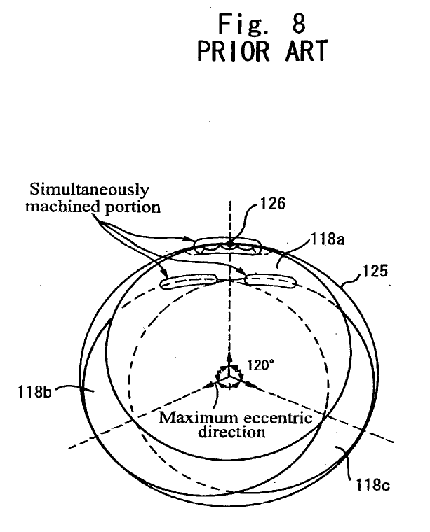

FIG. 9 is a diagram showing angle transmission errors in the conventional wobbling inner gearing planetary gear system.

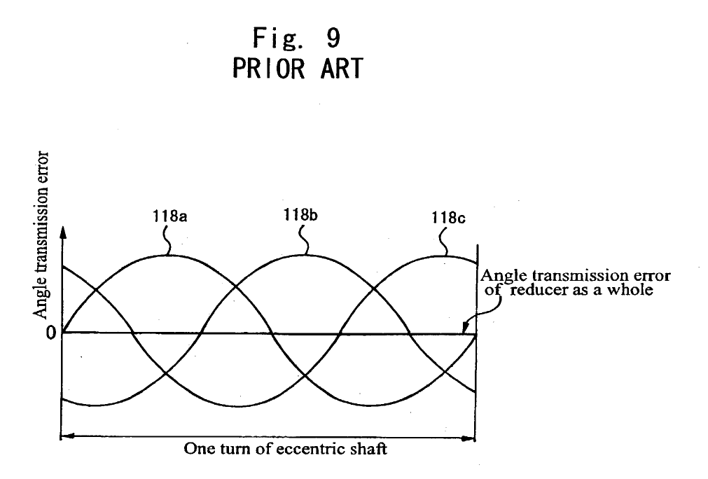

### DETAILED DESCRIPTION OF THE PREFERRED EMBODIMENTS

Preferred embodiments of the present invention will be hereinafter described with reference to the accompanying drawings.

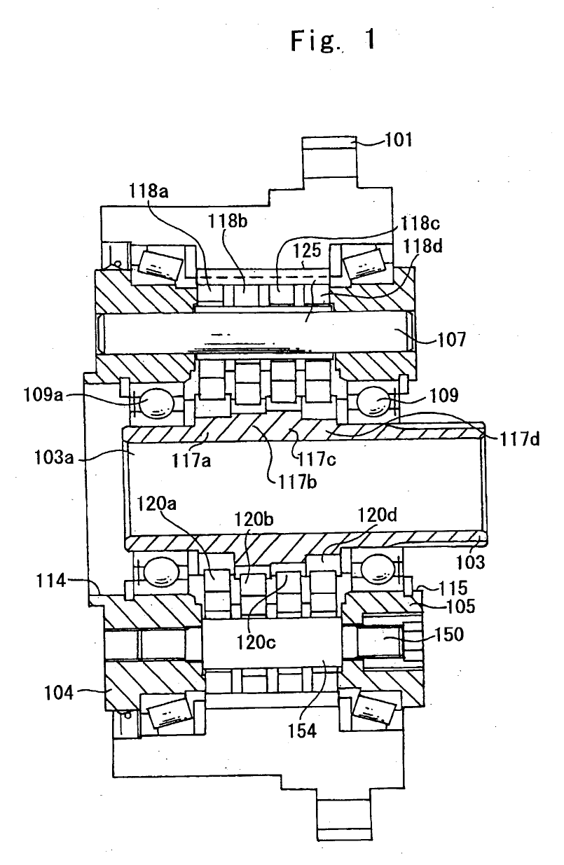

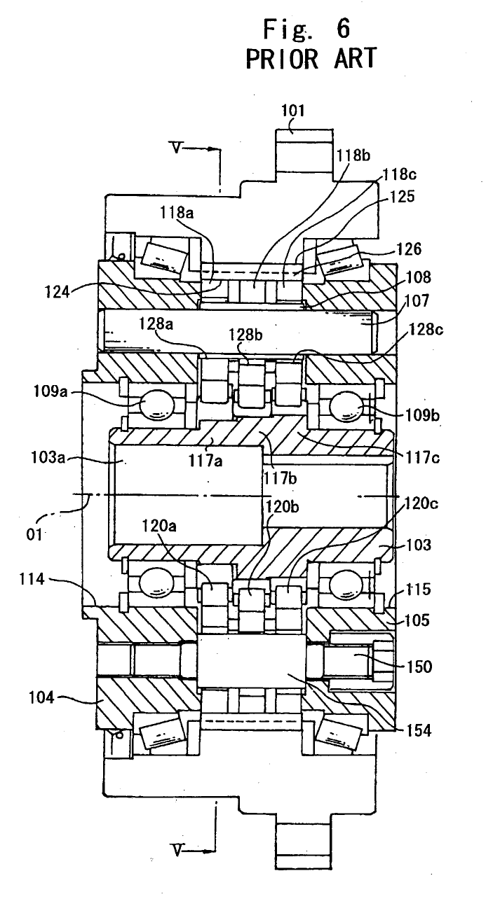

FIG. 1 is a sectional side view illustrating a wobbling inner gearing planetary gear system (reducer) according to one embodiment of the present invention. The drawing shows a part corresponding to the part shown in FIG. 6.

The reducer shown in FIG. 1 has substantially the same power transmission structure as the three-gear system shown in FIG. 6, apart from the feature that it has four (X=4) external gears 118a-118d (the reducer will be hereinafter referred to as “four-gear system”). Same or similar constituent elements are given the same reference numbers as those of FIG. 6 and detailed description thereof will be omitted.

On the outer periphery of the input shaft 103 between the bearings 109a and 109b are integrally formed eccentric elements 117a-117d, offset from each other by a predetermined phase difference (90° in this example). The four external gears 118a-118d are attached to these eccentric elements 117a-117d respectively by means of bearings 120a-120d.

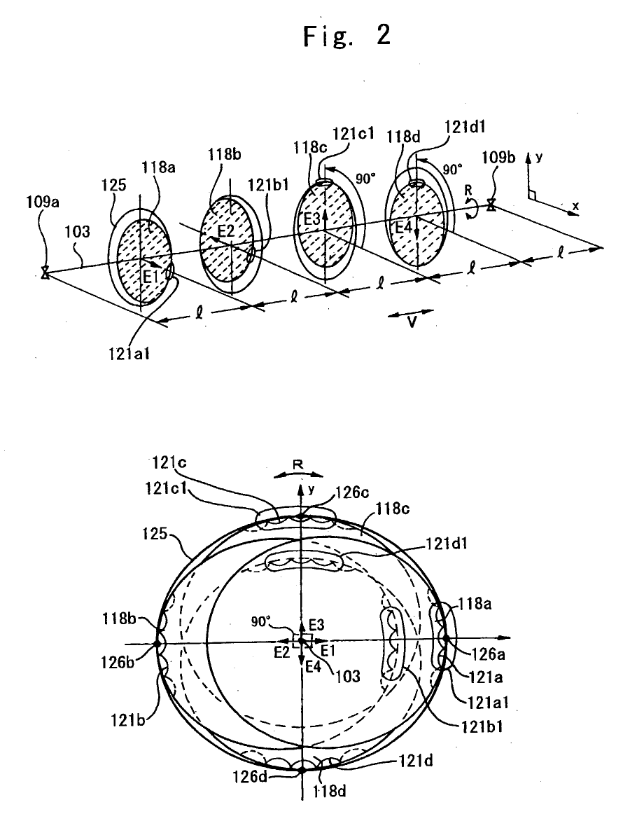

The following is an explanation of the numbers of teeth of external gears 118a-118d and internal gear 125 with reference to FIG. 2.

FIG. 2 is a model view illustrating the external gears 118a-118d of the four-gear system and the vicinity of the center axis 01 of the wobbling inner gearing planetary gear system, which coincides with the center of the input shaft 103.

The number of teeth of the internal gear 125 is X·n, where X is the number of external gears, 4 in this case, and n is an integer. The number of teeth of the internal gear 125 in the four-gear system of this embodiment is therefore 4n, a multiple of 4.

This is because the internal gear 125 needs to have its outer pins 126a-126d respectively in offset directions E1-E4 of the four external gears 118a-118d as shown in FIG. 2 so that all the external gears 118a- 118d make engagement with the inner pins.

The difference in the number of teeth between the internal gear 125 and external gears 118a-118d is two. The number of teeth of each of the external gears 118a-118d is therefore (the number of teeth of internal gear)—(difference in the number of teeth)=4n−2=2(n−1), hence an even number.

These external gears 118a-118d are assembled into the system as follows:

The external gear teeth 121a-121d of the four external gears 118a-118d and through holes therein such as inner roller holes 128a-128d are simultaneously formed to a set of four external gear material plates superposed upon one another. Therefore, the machining errors of these components are substantially the same in each of the obtained external gears 118a-118d.

The four external gears 118a-118d are divided into two pairs 118a, 118b and 118c, 118d, and after mounting the first pair 118a, 118b, the second pair 118c, 118d is mounted at respective positions circumferentially offset by 360°/4=90° around the input shaft 103 relative to the first pair 118a, 118b. Then, one of each pair, 118b and 118d, is respectively shifted parallel to an opposite direction E2, E4, by 180°, of the maximum offset direction E1, E3 of the other one of each pair, 118a, 118c.

As a result, as shown in FIG. 2, the simultaneously machined portions 121a1, 121b1 of the external gear teeth 121a, 121b of the pair of external gears 118a, 118b are in engagement with internal gear 125 at respective positions offset from each other by a phase difference of 180°, and the same goes with the simultaneously machined portions 121c1, 121d1 of the external gear teeth 121c, 121d of the pair of external gears 118c, 118d.

According to the method of assembling external gears 118a-118d described above, two external gears forming the pairs 118a, 118b and 118c, 118d having a 180° phase difference are respectively arranged adjacent to each other in the axial direction V of the input shaft 103.

Because the four external gears 118a-118d are equally spaced in the circumferential direction R of the input shaft 103, the loads created around the input shaft 103 are counterbalanced within the system.

Moreover, the simultaneously machined portions 121a1-121d1 of the external gear teeth 121a-121d of each two external gears 118a, 118b and 118c, 118d are in engagement with the internal gear 125 at positions offset from each other by a 180° phase difference. Therefore, the angle transmission errors created by the four external gears 118a-118d are counterbalanced respectively between one pair of external gears 118a, 118b and between the other pair of external gears 118c, 118d. Angle transmission errors in the entire system can thereby be reduced.

Furthermore, because the two external gears forming the pairs 118a, 118b and 118c, 118d having a 180° phase difference are respectively arranged adjacent to each other in the axial direction V of the input shaft 103, the moments caused by the eccentric motion of the external gears 118a-118d can also be well counterbalanced.

In addition, because the difference in the number of teeth between the inner and external gears is two, a higher reduction rate is achieved as compared to the prior art in which the difference in the number of teeth is a multiple of an integer of the number of teeth of external gears.

In this embodiment, the pair of external gears 118a, 118b and the pair of external gears 118c, 118d both having a 180° phase difference are respectively arranged adjacent to each other in the axial direction V of the input shaft 103 as shown in FIG. 2, but the present invention is not limited to this arrangement.

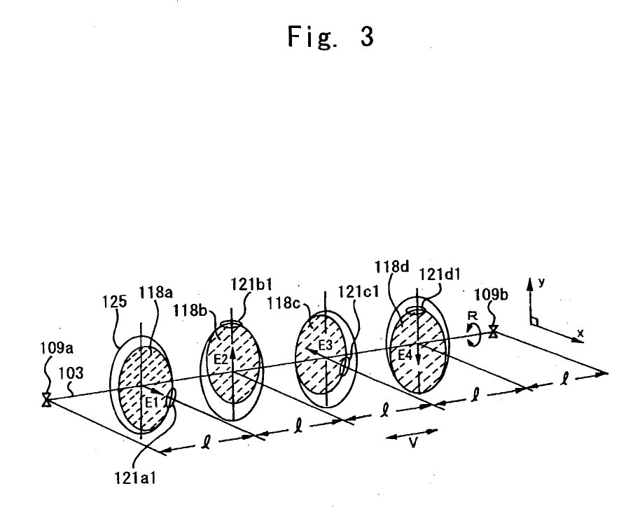

For example, the four external gears 118a-118d may be arranged as shown in FIG. 3, in which the simultaneously machined portions 121a1, 121c1 of the external gear teeth 121a, 121c of the pair of external gears 118a, 118c are in engagement with internal gear 125 at respective positions offset from each other by a phase difference of 180°, and the same goes with the simultaneously machined portions 121b1, 121d1 of the external gear teeth 121b, 121d of the pair of external gears 118b, 118d. Thereby, a high speed reduction/increase rate is achieved, and angle transmission errors are reduced. In other words, the paired external gears need not necessarily be arranged adjacent to each other in the axial direction.

The number of teeth of external gears is four in the above embodiment, but the present invention is obviously not limited to this, and the number of teeth of external gears may be any even number more than 4.

For example, it is possible to construct a wobbling inner gearing planetary gear system with six external gears (hereinafter referred to as “six-gear system”).

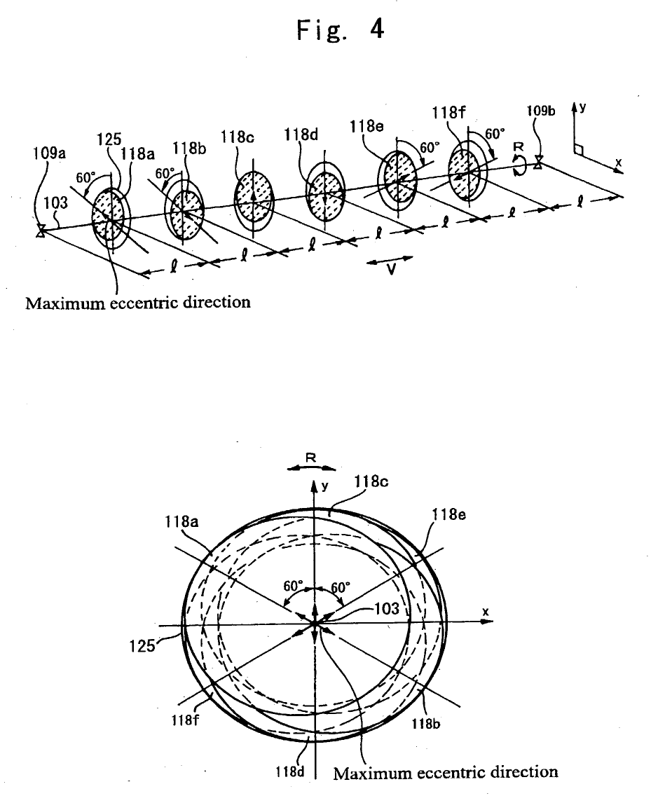

FIG. 4 is a model view illustrating external gears 118a-118f of such six-gear system and the vicinity of the center axis 01 of the wobbling inner gearing planetary gear system coinciding with the center of the input shaft.

The number of teeth of the internal gear 125 is a multiple of 6, 6n (n: integer), and the difference in the number of teeth between the internal gear 125 and external gears 118a-118f is 2 in this six-gear system. The six external gears 118a-118f are subjected to machining in a state wherein they are superposed upon one another so as to form respective external gear teeth (not shown) and through holes in each of the external gears.

The six external gears 118a-118f are grouped into three pairs 118a-118b, 118c-118d, 118e-118f, and these pairs are rotated relative to each other around the input shaft 103 so that each pair is mutually offset by 360°/6=60° in the circumferential direction R of the input shaft 103. One of each pair of external gears 118b, 118d, 118f is then shifted parallel in 180° opposite direction away from the other one of each pair of external gears 118a, 118c, 118e.

By thus arranging the external gears, the angle transmission errors caused by the six external gears 118a-118f are well counterbalanced between each pair of external gears 118a-118b, 118c-118d, 118e-118f. As a result, the angle transmission errors in the system as a whole are reduced, and at the same time the transmission capacity of the system is increased due to the larger number of external gears.

Furthermore, in this embodiment, an eccentric position is successively determined such that adjacent external gears are offset from each other by a maximum phase difference with reference to an eccentric position of an immediately previously mounted external gear, and the six external gears 118a-118f are mounted one by one at the determined eccentric position. Thus, the moments caused by the external gears 118a-118f are effectively counterbalanced.

Also, a high speed reduction/increase rate is achieved as with the four-gear system because the difference in the number of teeth between the inner and external gears is 2.

Although the internal gear 125 is stationary in this embodiment, the system can also be constructed such that the output shafts 104, 105 are made stationary, while the internal gear 125 is made movable as an output shaft. Also, the system can be constructed as a speed increaser simply by reversing the input and output sides.

As described above, the present invention provides a method of manufacturing a wobbling inner gearing planetary gear system having an even number of 4 or more of external gears, by which the system is made compact and its transmission capacity increased, and by which a high speed reduction/increase rate is achieved while angle transmission errors are reduced.

What is claimed is:

1. A method of manufacturing a wobbling inner gearing planetary gear system having planetary external gears and an internal gear with which said external gears internally mesh, a center axis of the system being located inside periphery of the external gears, the method comprising the steps of:
setting a number of teeth for the internal gear as X·n, where X is an even number more than 4 and n is an integer,
setting a difference in a number of teeth between said internal gear and external gears as 2;
machining said external gears in a number of X in a state wherein they are superposed upon one another to collectively form their respective external gear teeth and through holes; and
assembling said external gears in the system in such an arrangement that said external gears are grouped into pairs and said pairs of the external gears are circumferentially offset relative to each other by 360°/X around said center axis, and that one of each pair of external gears is shifted parallel in 180° opposite direction away from the other one of each pair of external gears.

2. The method of manufacturing a wobbling inner gearing planetary gear system according to claim 1, wherein two of said X external gears forming said pairs are respectively arranged adjacent to each other in an axial direction of said center axis.

3. The method of manufacturing a wobbling inner gearing planetary gear system according to claim 1, wherein an eccentric position where axially adjacent external gears are offset from each other by a maximum phase difference with reference to an eccentric position of an immediately previously mounted external gear is successively determined, and said X external gears are assembled successively in an axial direction of said center axis at said determined eccentric position.

4. A method of manufacturing a wobbling inner gearing planetary gear system having planetary external gears and an internal gear with which said external gears internally mesh, a center axis of the system being located inside periphery of the external gears, the method comprising the steps of:
preparing the internal gear whose number of teeth is X·n, where X is an even number more than 4 and n is an integer,
machining said external gears in a number of X in a state wherein they are superposed upon one another to collectively form their respective external gear teeth and through holes, so that a difference in number of teeth between the internal and the external gears are 2; and
assembling said external gears in the system in such an arrangement that said external gears are grouped into pairs and said pairs of the external gears are circumferentially offset relative to each other by 360°/X around said center axis, and that one of each pair of external gears is shifted parallel in 180° opposite direction away from the other one of each pair of external gears.

5. A wobbling inner gearing planetary gear system comprising:
planetary external gears, and
an internal gear with which said external gears internally mesh, a center axis of the system being located inside periphery of the external gears, wherein
said internal gear is provided with teeth in a number of X·n, where X is an even number of 4 or more and n is an integer;
said internal gear and external gears have a difference of 2 in their number of teeth;
said external gears in a number of X are assembled in an axial direction of said center axis, said X external gears being machined simultaneously in a state wherein they are superposed upon one another to collectively form their respective external gear teeth and through holes;
said X external gears are grouped into pairs and said pairs of external gears are offset from each other by 360°/X; and
one of each pair of external gears is shifted parallel in 180° opposite direction away from the other one of each pair of external gears.

6. The system according to claim 5, wherein two of said X external gears forming said pairs are respectively arranged adjacent to each other in said axial direction of the center axis.

7. The system according to claim 5, wherein said X external gears are arranged in said axial direction of the center axis at an eccentric position where axially adjacent external gears are offset from each other by a maximum phase difference with reference to an eccentric position of an immediately previously mounted external gear.
